(19) United States
(12) Patent Application Publication
(10) Pub. No.: US 2023/0322549 A1
(43) Pub. Date: Oct. 12, 2023

(54) METHODS AND SYSTEMS FOR CRYOGENICALLY SEPARATING CARBON DIOXIDE AND HYDROGEN FROM A SYNGAS STREAM

(71) Applicant: Decarbtek Global Corp., Stirling (CA)

(72) Inventors: Henry Gil, Calgary (CA); Andrew Squires, Stirling (CA)

(21) Appl. No.: 18/133,620

(22) Filed: Apr. 12, 2023

Related U.S. Application Data
(60) Provisional application No. 63/330,212, filed on Apr. 12, 2022.

(51) Int. Cl. C01B 3/02; C01B 3/38; F25J 3/02

(52) U.S. Cl. CPC C01B 3/025; C01B 3/382; F25J 3/0223; F25J 3/0252; F25J 3/0266; C01B 2203/0475; C01B 2203/0283; F25J 2205/64; C01B 2203/068; F25J 2205/80; F25J 2210/18; F25J 2215/10; F25J 2220/80; F25J 2245/00

(57) ABSTRACT

The disclosure relates generally to methods as well as configurations for cryogenically separating carbon dioxide and hydrogen and particularly to methods and configurations for cryogenically separating carbon dioxide and hydrogen from a syngas stream to produce high quality carbon dioxide stream(s) and/or high quality hydrogen stream(s). In an embodiment, a system for cryogenically separating carbon dioxide from a syngas stream comprises a pressure swing adsorption system, wherein the pressure swing adsorption (PSA) system separates a syngas input stream into a hydrogen-rich stream and a carbon dioxide-rich stream. The PSA unit outputs the hydrogen-rich stream and the carbon dioxide-rich stream and a carbon dioxide capturing unit cryogenically converts the carbon dioxide-rich stream to a dense phase. The hydrogen-rich stream may be used as a fuel source and/or a feedstock for chemical synthesis, and the dense phase carbon dioxide may be sequestered and stored, or used as a chemical feedstock.

### CROSS REFERENCE TO RELATED APPLICATION

The present application claims the benefits of U.S. Provisional Application Ser. No. 63/330,212, filed Apr. 12, 2022, entitled “METHOD TO CRYOGENICALLY SEPARATE CARBON DIOXIDE FROM A SYNGAS STREAM”, which is incorporated herein by this reference in its entirety.

### FIELD

The disclosure relates generally to methods as well as configurations for cryogenically separating carbon dioxide and hydrogen and particularly to methods and configurations for cryogenically separating carbon dioxide and hydrogen from a syngas stream.

### BACKGROUND

The petrochemical industry relies on hydrogen, nitrogen, and oxygen gases for many of its processes to manufacture certain known commodities like polymers, ammonia, olefins and other chemicals. Similarly, with the global energy transition into low carbon fuels and low carbon energy, oxygen manufacture plays an important role in oxy-combustion and pre-combustion carbon dioxide (CO₂) capture particularly with power generation and fertilizer production. Additionally, ammonia (NH₃) is presently being explored and tested as an alternative marine fuel and as a safe means to store and transport hydrogen because ammonia does not require the cryogenic storage temperatures of −280° C. that hydrogen does. Ammonia liquid, like propane, is in a liquid state at about −35° C. and can be stored and transported in liquid form in atmospheric cryogenic tanks or at about 300 psig in pressurized vessels at ambient temperatures.

Hydrogen can be manufactured from natural gas or renewable biomass utilizing auto-thermal reforming, biomass pyrolysis, gasification, or plasma yielding syngas containing carbon dioxide. Carbon dioxide has long been in the forefront of climate change resulting in global warming and global weather extremes, causing significant damage to infrastructure around the world. Governments, in a collaborative manner, have worked together to reduce and limit carbon dioxide emissions and to capture and dispose carbon efficiently to limit its effects on the planet. Since the 1900's society has relied heavily on fossil fuels, such as coal and petroleum, and the world has reached a critical stage to limit the use of these energy fuels to maintain quality of life. Over the next few years, a transition into low carbon fuels and eventually fully transitioning into renewables seems to be the global trend. There is thus a need for sustainable methods and systems that effectively capture carbon dioxide and likewise for methods and systems capable of producing renewable fuel sources, such as high-purity hydrogen.

### SUMMARY

These and other needs are addressed by the various aspects, embodiments, and configurations of the present disclosure.

The present disclosure provides an integrated method for separating carbon dioxide and hydrogen from a syngas stream. In embodiments of the present disclosure, the separated carbon dioxide may be captured and stored, for example, and the separated carbon-free hydrogen may be utilized as a fuel for power generation and/or feedstock for ammonia synthesis. The methods and systems disclosed herein integrate one or more systems capable of carbon dioxide liquefaction (e.g., air separation units (ASUs), an ammonia compression refrigeration system, a propane compression refrigeration system, an ammonia aqueous refrigeration system, a liquefaction column, a Joule Thomas (JT) valve, multi-stage compressors, a turboexpander, or a combination thereof) with systems that produce hydrogen and carbon dioxide blended syngas(s), such as an auto-thermal reformer (ATR), to cryogenically separate carbon dioxide from a hydrogen-containing syngas.

In aspects of the present disclosure, a system comprises an auto-thermal reformer, wherein the auto-thermal reformer comprises a natural gas inlet stream and outputs a syngas stream comprising at least carbon dioxide and hydrogen; a pressure swing adsorption system that receives the syngas stream as an input, wherein the pressure swing adsorption system separates the syngas stream into a hydrogen-rich stream and a carbon dioxide-rich stream, and wherein the pressure swing adsorption system outputs the hydrogen-rich stream and the carbon dioxide-rich stream; and an air separation unit comprising a gas having a cryogenic temperature, wherein the gas is thermally contacted with the carbon-dioxide rich stream to cool the carbon dioxide-rich stream to the cryogenic temperature and form a dense phase.

In embodiments, the system further comprises a molecular sieve dryer following the pressure swing adsorption system, wherein the molecular sieve dryer removes water from the carbon dioxide-rich stream.

In embodiments, the system further comprises one or more multi-stage compressors, wherein the one or more multi-stage compressors are located subsequent to the pressure swing adsorption system, and wherein the one or more multi-stage compressors are located prior to the molecular sieve dryer, or subsequent to the molecular sieve dryer, or a combination thereof.

In embodiments, the system further comprises one or more membranes following the pressure swing adsorption system that separate remaining hydrogen from the carbon dioxide-rich stream, wherein the one or more membranes output a second hydrogen rich-stream that is recycled to the pressure swing adsorption system and output a second carbon dioxide-rich stream.

In embodiments, the gas having the cryogenic temperature comprises nitrogen, carbon dioxide, or both.

In embodiments, the auto-thermal reformer is integrated with a high-temperature shift reactor and a low-temperature shift reactor, and wherein an output of the auto-thermal reformer is an input to the high-temperature shift reactor, and an output of the high-temperature shift reactor is an input to the low-temperature shift reactor.

In embodiments, the system further comprises a flooded tube chiller integrated with a propane or ammonia compression refrigeration cycle that aids in the cryogenic conversion of the carbon dioxide-rich stream to the dense phase.

In embodiments, the system further comprises a cogeneration power plant, wherein the hydrogen-rich stream is input to the cogeneration plant as a fuel source.

In embodiments, the system further comprises an ammonia synthesis system, wherein the hydrogen-rich stream and nitrogen are input to the ammonia synthesis system to synthesize ammonia.

In aspects of the present disclosure, a system comprises a pressure swing adsorption system comprising a syngas stream as an input, wherein the pressure swing adsorption system separates the syngas stream into a hydrogen-rich stream and a carbon dioxide-rich stream, and wherein the pressure swing adsorption system outputs the hydrogen-rich stream and the carbon dioxide-rich stream; and a carbon dioxide capturing unit that receives the carbon-dioxide rich stream and cryogenically converts the carbon dioxide-rich stream to a dense phase.

In embodiments, the carbon dioxide capturing unit comprises a compression cycle comprising one or more of a flooded tube chiller, a cross exchanger, a screw compressor, a condenser, and an accumulator, wherein the compression cycle is an ammonia or propane compression cycle.

In embodiments, the carbon dioxide capturing unit comprises an ammonia aqueous cycle comprising one or more of an aqueous ammonia generator, an exothermic absorber, a rectifier, a Joule Thomson valve, and a flooded tube chiller.

In embodiments, the carbon dioxide capturing unit comprises one or more multi-stage compressors, polishing membranes, and molecular sieve dryers.

In embodiments, the carbon dioxide capturing unit comprises a liquefaction column, a Joule Thomas valve, a turboexpander, or a combination thereof.

In embodiments, the carbon dioxide capturing unit comprises a cold box associated with an air separation unit, wherein the carbon-dioxide rich stream is thermally contacted with cryogenic nitrogen liquids from the air separation unit.

In embodiments, the carbon dioxide capturing unit comprises a de-oxy system to achieve a particular oxygen content in the carbon-dioxide rich stream.

In embodiments, the system further comprises one or more of a cogeneration power plant and an ammonia synthesis unit, wherein the hydrogen-rich stream is input to the cogeneration plant as a fuel source, and wherein the hydrogen-rich stream is input to the ammonia synthesis unit with nitrogen to synthesize ammonia.

In aspects of the present disclosure, a method comprises producing, from a natural gas stream, a syngas comprising at least hydrogen and carbon dioxide; separating at least a portion of the hydrogen from the syngas using pressure swing adsorption to form a hydrogen-rich stream and a carbon dioxide rich stream; and passing the carbon dioxide-rich stream through a carbon dioxide capture unit to cryogenically convert the carbon dioxide-rich stream to a dense phase to form dense phase carbon dioxide.

In embodiments, passing the carbon dioxide-rich stream comprises thermally contacting a gas having a cryogenic temperature from an air separation unit to cryogenically convert the carbon dioxide-rich stream to the dense phase carbon dioxide.

In embodiments, the method further comprises using the gas having the cryogenic temperature from the air separation unit as a refrigerant for ammonia liquefaction in an ammonia synthesis process.

In embodiments, the method further comprises using the gas having the cryogenic temperature from the air separation unit as a refrigerant for hydrogen liquefaction in a hydrogen synthesis process.

In embodiments, the method further comprises sequestering the dense phase carbon dioxide in a storage unit, earth subsurface, or an aquifer, indefinitely.

In embodiments, the method further comprises passing the hydrogen-rich stream to a cogeneration power plant, wherein the hydrogen-rich stream is input to the cogeneration plant as a fuel source.

In embodiments, the method further comprises passing the hydrogen-rich stream to an ammonia synthesis unit, wherein the hydrogen-rich stream is input to the ammonia synthesis unit with nitrogen to synthesize ammonia.

In embodiments, the carbon dioxide capture unit comprises one or more of an ammonia compression cycle, a propane compression cycle, an ammonia aqueous cycle, a multi-stage compressor, a polishing membrane, a molecular sieve dryer, a liquefaction column, a Joule Thomas valve, a turboexpander, a cold box associated with an air separation unit, and a de-oxy system.

As such, the present disclosure provides an integrated method for the capture of carbon dioxide, while utilizing carbon-free hydrogen as a fuel for power generation and feedstock for ammonia synthesis. In embodiments, the process also provides the usage of a cryogenic ASU fluid stream (i.e., nitrogen and/or carbon dioxide) as a refrigerant for ammonia synthesis liquefaction. In embodiments, the process may utilize one or more systems capable of carbon dioxide liquefaction, such as the ASU, an ammonia compression refrigeration system, a propane compression refrigeration system, an ammonia aqueous refrigeration system, one or more liquefaction columns, a JT valve, multi-stage compressors (e.g., multistage Dresser-Rand Ramgen compressors), a turboexpander, or a combination thereof. Other methods of manufacturing hydrogen such as an air based steam methane reformer (SMR), partial oxidation (POX) reformers, gasification, plasma arc, pyrolysis, thermal degradation of methane or other fossil commodities may be integrated with one or more of the systems capable of carbon dioxide liquefaction to cryogenically separate carbon dioxide from hydrogen.

The disclosed processes bridge the gap for hydrogen fuel production and power generation and decarbonizes ammonia for use as a fertilizer or as a fuel, thus reducing the complexity and capex associated with power generation and ammonia manufacturing. Additionally, the disclosed processes assist in the transition from blue hydrogen to turquoise hydrogen from fossil fuels and other renewable processes.

As described herein, refrigerants and refrigeration cycles are used to separate, through liquefaction, the necessary molecular building block elements for further petrochemical processing. The integration of the hydrogen manufacturing process and the oxygen and nitrogen manufacturing processes rely on each-other's manufactured products to produce a commodity product for sale. The present processes are self-generating inside the boundary limits of their respectful licensed process to provide the elements across the inter-plant boundary limits such as, nitrogen, oxygen, hydrogen, carbon dioxide, etc.

In the manufacture of polymers, ammonia and other chemicals, refrigeration processes are a known requirement to separate and liquefy certain streams. Integrating processes with an ASU and utilizing the liquefaction refrigerant of the ASU allows for the use of that refrigerant to separate carbon dioxide into dense-phase carbon dioxide (e.g., carbon dioxide in a supercritical liquid state that demonstrates the properties of both a liquid and a gas) and hydrogen gas. Similarly, the liquid air, primarily nitrogen, from the ASU can be utilized as a refrigerant liquefaction cycle to condense gases associated with other with petrochemicals and chemicals, such as ammonia gases. Such a process results in significant costs saving and avoids the need for a process licensor to supply their own refrigeration processes inside their respective plant boundary limits. Integrating the processes will require a higher energy duty for the ASU liquefaction of air, however it provides for less equipment costs and synergies associated with economies of scale with respect to refrigeration. Similarly, other refrigeration cycles such as water-ammonia refrigeration and other known refrigeration cycles can be utilized. The disclosed methods and systems are cost effective and may not require a large footprint compared to traditional methods.

In some embodiments, PSA may be used in combination with stream compression and syngas drying to further facilitate separation of carbon dioxide and hydrogen (H₂) effectively without producing solid carbon dioxide. The hydrogen may separate easily from the carbon dioxide because the carbon dioxide is concentrated by the PSA. For example, a PSA separates hydrogen from the carbon dioxide, however there may be hydrogen slip where some hydrogen may remain with the carbon dioxide and other impurities. In some embodiments, cryogenic temperatures and pressures may further separate the hydrogen carryover and concentrate the carbon dioxide into a liquid or dense phase. In some embodiments, carryover hydrogen from the PSA or other separator may be further polished by allowing the high purity small hydrogen molecule to pass through one or more polishing membranes thus separating the hydrogen and carbon dioxide, where the carbon dioxide may be recycled back to the liquefaction process and the hydrogen may be joined with the hydrogen-rich stream (that exited the PSA) and/or recycled back to the PSA.

The impacts of carbon dioxide and global warming are significant and carbon capture technologies and methods are a developing and evolving science with significant research being conducted on a global basis in efforts to abate climate change. Decarbonation of fuels to a hydrogen economy and chemical fertilizers such as ammonia provides society with a means of continuing to utilize the traditional clean fuels such as natural gas and to continue to expand food production yields through nitrogen fertilizers. After transport fuels, power generation, and concrete manufacturing, fertilizers are one of the lead contributors to carbon dioxide emissions. Additionally, the manufacturing of hydrogen primarily utilizes steam methane-based technologies that utilize air for combustion and processing, making it difficult to efficiently capture carbon dioxide for sequestration because of the large amounts of nitrogen (N₂). Amine salts, solvents and other processes may conventionally be used to capture carbon; however, its capture efficiency is limited to approximately 85-90% only as compared to the process disclosed herein which has greater than 99% carbon dioxide capture efficiency with significant cost efficiencies.

As used herein, unless otherwise specified, the term “blue hydrogen” refers to hydrogen produced from natural gas and supported by carbon capture and storage, where the carbon dioxide generated during the manufacturing process is captured and stored permanently underground. The result of “blue hydrogen” is low-carbon hydrogen that produces no carbon dioxide.

As used herein, unless otherwise specified, the term “turquoise hydrogen” refers to hydrogen produced from a process where a hydrocarbon fuel is thermally cracked into hydrogen and carbon.

As used herein, unless otherwise specified, the term “blue ammonia” refers to ammonia that is made from nitrogen and “blue hydrogen” derived from natural gas feedstocks, with the carbon dioxide by-product from hydrogen production being captured and stored.

As used herein, unless otherwise specified, the term “liquefaction” refers to a process by which a substance is liquefied or converted to a dense phase.

As used herein, unless otherwise specified, the term “thermally contacted” refers to a process by which two or more streams exchange energy, such as heat, and it should be understood that the content of the two or more streams do not come into physical contact with one another such that the content of the two or more streams do not mix.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is an example blue power process that supports methods and systems for cryogenically separating carbon dioxide and hydrogen from a syngas stream;

FIG. 2 is an example blue ammonia process that supports methods and systems for cryogenically separating carbon dioxide and hydrogen from a syngas stream;

FIG. 3 is an example process using pressure swing adsorption (PSA) and a liquefaction chiller that supports methods and systems for cryogenically separating carbon dioxide and hydrogen from a syngas stream;

FIG. 4 is an example process using liquefaction cycles that supports methods and systems for cryogenically separating carbon dioxide and hydrogen from a syngas stream;

FIG. 5 is an example process using a PSA and expander liquefaction that supports methods and systems for cryogenically separating carbon dioxide and hydrogen from a syngas stream;

FIG. 6 is an example process using a PSA and an air separation unit (ASU) that supports methods and systems for cryogenically separating carbon dioxide and hydrogen from a syngas stream; and

FIG. 7 is an example process using a PSA and carbon dioxide compression that supports methods and systems for cryogenically separating carbon dioxide and hydrogen from a syngas stream.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

The present disclosure provides improved methods for capturing and separating carbon dioxide and hydrogen from a syngas stream. In some embodiments, an auto thermal process can be utilized with one or more water gas shift reactions to convert carbon monoxide into a highly concentrated carbon dioxide stream. The carbon dioxide may be separated and captured with pressure swing adsorption and at cryogenic temperatures producing carbon dioxide for sequestration and enhanced oil recovery into a subsurface reservoir. The carbon dioxide can be disposed and stored in a safe manner indefinitely. The disclosed processes utilizes natural gas, decarbonizes the natural gas and returns the carbon dioxide back into the subsurface where it originally came, yet utilizing the hydrogen from the natural gas for the future hydrogen economy and/or for the manufacture of ammonia for food production and petrochemical usage, among other uses.

The processes, methods, and systems, disclosed herein efficiently integrate a natural gas and/or syngas fluid stream from an auto-thermal reformer (ATR) and/or other similar processes producing a hydrogen and carbon dioxide blended syngas, with processes such as plasma arc pyrolysis, gasifiers, and other processes, to cryogenically separate carbon dioxide from H2 syngas, to yield separate high-quality streams of hydrogen and carbon dioxide. The cryogenic processes may be utilized without nitrogen. The high-quality hydrogen may be used as a fuel for clean power generation and/or as a chemical feedstock. Similarly, the high-quality carbon dioxide may be used as a chemical feedstock or simply disposed and sequestered, such as into a deep saline aquifer deep in the subsurface. The process may utilize the cryogenic liquids from the air separation unit (ASU) and/or hydrocarbon or ammonia refrigerant cycles at cryogenic temperatures. The cryogenic liquids may act a refrigerant to separate carbon dioxide from a syngas stream, without requiring alternate costly and energy consuming conventional methods of amine absorption or methanol-based solvent regenerative processes to capture the carbon dioxide and other carbon molecules in the syngas.

The ASU process products may be utilized to operate in a refrigerant capacity and also may be applied to any other process refrigeration cycles such as a hydrocarbon liquefaction processes, ammonia liquefaction processes, and other chemical processes that normally would utilize a compression, chiller and regeneration refrigeration process, either in an integrated manner or in a cascaded fridge cycle to separate or condense a gas stream.

The disclosed methods and systems are of significant importance in hydrogen generation, such as from natural gases, natural gas liquids, petroleum hydrocarbon liquids, and from hydrocarbon solids or liquid gasification methods utilizing oxygen gasification, inclusive but not limited to biomasses and any other material containing hydrogen that can be converted into hydrogen gas for energy or petrochemical utilization. The disclosed methods and systems also apply to biomass and biofuels pyrolysis processes and any other process utilizing an ASU to generate oxygen for the manufacturer of hydrogen and hydrogen derivatives; to renewable energy such as solar, wind, geothermal, wave energy, hydro energy, energy from calorific wastes, electrolysis; and any combination thereof where an ASU is utilized for the generation of hydrogen and hydrogen derivatives. The present disclosure applies to power generation methods to separate carbon dioxide as a capture process and methods of liquefying ammonia, in an ammonia synthesis process.

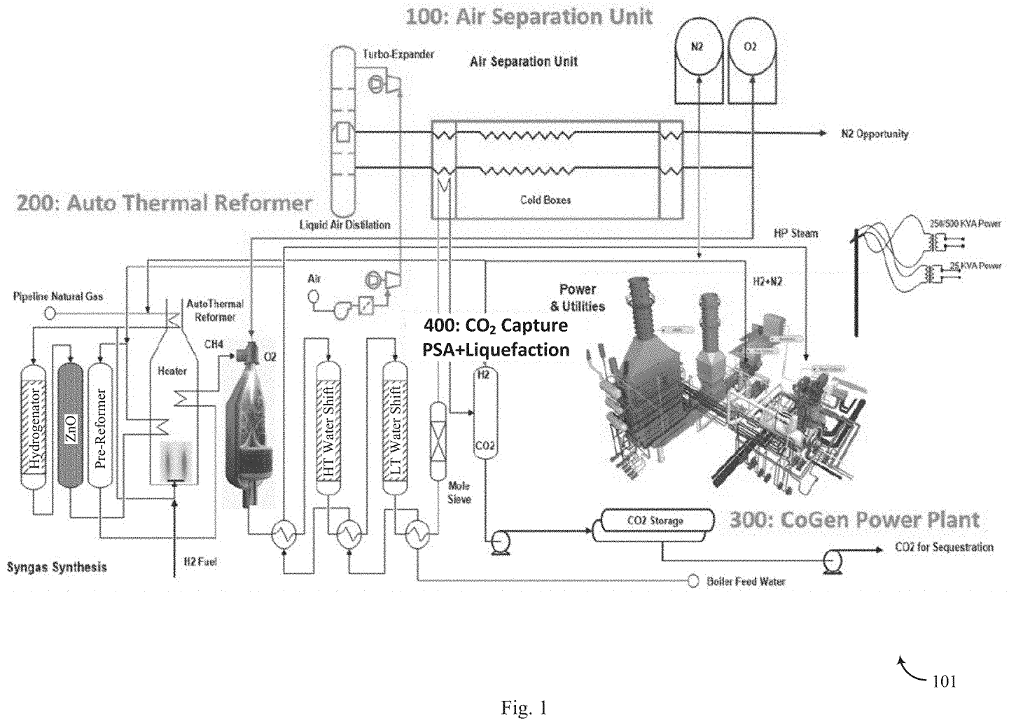

With reference to FIG. 1, an example of a blue power process 101 that supports methods and systems for cryogenically separating carbon dioxide and hydrogen from a syngas stream according to the present disclosure is depicted. The process 101 may be an example blue power process capable of ASU-ATR-cogeneration (CoGen) hydrogen fuel production and cryogenic carbon dioxide capture.

A blue power generation process 101 that manufactures hydrogen for combustion in the gas turbine and heat recovery steam generators (HRSG) to generate steam, integrates manufactured steam with the steam turbine cycle and utilizes the cryogenic nature of the air separation unit (ASU) as a refrigerant in combined cycle power applications. In lieu of utilizing the ASU for liquefaction of the carbon dioxide, a compression or chiller liquefaction may be utilized with a flood tube chiller or the like, as described herein. Similarly, should the ASUbe designed with extraction of noble air gases such as argon, helium etc., the ASU gases may be utilized not only for liquefaction of carbon dioxide, but also the liquefaction of hydrogen for use in supporting the energy transition to net-zero fuels.

The blue process 101 may comprise a system 100, where the system 100 may comprise and ASU including a booster air compressor (BAC), a main air compressor (MAC), a mole sieve air dryer (not shown), reversing cold boxes, a turbo expander, a gel trap, a super heater box, an upper and lower distillation column with a condenser reboiler and gel trap, or a combination thereof. The blue process 101 may additionally comprise a system 200, where the system 200 may comprise an ATR process, further described below, to generate hydrogen. The blue process 101 may additionally comprise a system 300, including a CoGen power plant utilizing the generated hydrogen fuel from the ATR. The blue process 101 may additionally comprise a system 400 including a carbon dioxide capture process with a molecular sieve syngas dryer, vapor pressure swing adsorption (VPSA), and a refrigerant from the ASU and/or a conventional compression cycle or an ammonia-water cycle as described herein.

The methods and systems herein may be integrated with hydrogen generation from renewable power using solar, biomass, geothermal, and other generation methods that limit generation of carbon dioxide through the utilization of combustion air as significant amounts of nitrogen in the air result in carbon dioxide capture challenges and inefficiencies. For example, earth's air is naturally composed of nitrogen. Therefore, in some embodiments, the nitrogen may be compressed by BAC and MAC compressors then expanded to make liquid air (i.e., via an ASU) that is distilled into oxygen, nitrogen, and noble gases. Solar, geothermal, and hydroelectric technologies produce power that through the hydrolysis of water, will produce hydrogen. However, to produce ammonia, nitrogen is needed, such as from the air, which has to be separated through a membrane or cryogenically. Biomass is normally gasified through pyrolysis with oxygen and will produce carbon dioxide.

The blue power process 101 may capture carbon dioxide for sequestration and/or petroleum enhanced oil recovery (EOR) and sequestration into depleted oil reservoirs, resulting in improved economic recovery and permanently sequestering the carbon at the end of the resource life. The carbon dioxide may also be used with heavy oil reservoirs as a solvent in a blend of solvent gas such as carbon dioxide, propane, butanes, and other solvents.

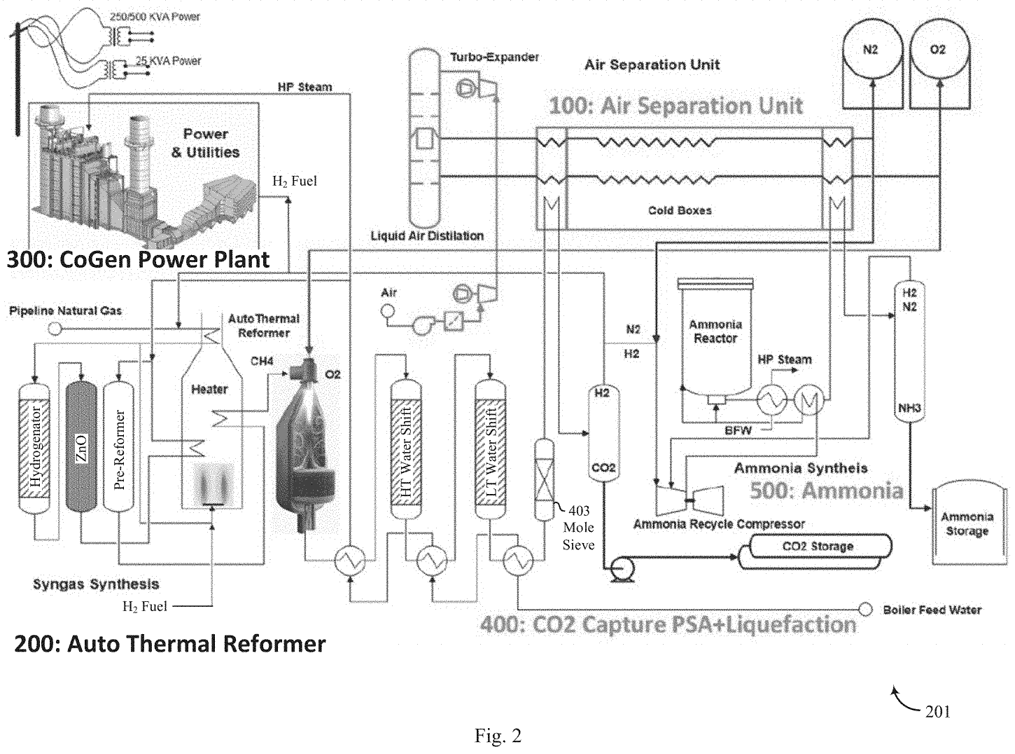

FIG. 2 depicts an example blue ammonia process 201 that supports methods and systems for cryogenically separating carbon dioxide and hydrogen from a syngas stream according to the present disclosure is depicted. The process 201 may be an example blue ammonia process capable of ASU-ATR-CoGen hydrogen fuel production and cryogenic carbon dioxide capture. Blue ammonia is a product of significant interest not only as a fertilizer for food production and other uses such as petrochemicals, explosives, etc., but also as a fuel for power, marine, rail, and other transport methods, blended with combustion accelerants. The ammonia may be cogenerated with blue power generation, blue ammonia, blue hydrogen and other processes. FIG. 2 may include a system 100, a system 200, a system 300, and a system 400, which may be the same or similar as system 100, system 200, system 300, and system 400 as described with reference to FIG. 1. Additionally, FIG. 2 may include a system 500 directed to ammonia synthesis.

An ATR system 200 for the production of hydrogen applied to power as in FIG. 1 and to ammonia as in FIG. 2 may include natural gas desulphurization, a pre-reformer, and oxy-auto-thermal methane reforming to hydrogen and carbon monoxide. The ATR system 200 may convert the carbon monoxide to carbon dioxide through high temperature and low temperature water shift reactions. Hydrogen purification may be performed by PSA. Carbon dioxide removal may be achieved by the PSA and cryogenic liquefaction of carbon dioxide by utilizing an independent refrigeration cycle or by integration with cryogenic ASU cold boxes. The ATR system 200 may further include process condensate recovery and/or a steam system integration into heat and power. For example, the high temperature water shift reaction may occur between about 200° C. and 600° C., and more particularly between about 300° C. and 500° C., and even more particularly at about 450° C. and may convert carbon monoxide to carbon dioxide by reacting the carbon monoxide with hydrogen in the gas stream. The low temperature water shift may occur between about 100° C. and 400° C., and more particularly between about 200° C. and 300° C., and even more particularly at about 230° C. and may further convert carbon monoxide to carbon dioxide by reacting with the carbon monoxide with the hydrogen in the stream. Steam may be added to facilitate the conversion and the steam and reaction water may condense into high quality steam/water condensate which may be recovered for the process recycle.

The systems and units depicted in FIGS. 1 and/or 2 are further described below.

### Auto-Thermal Reforming (ATR)

Auto thermal reforming is a combination of both steam methane reforming (SMR) and partial oxidation (POX) reforming. Auto thermal reforming is a relatively new method of reforming where methane is reacted with oxygen and steam. Products in the reforming reactor are both endothermic and exothermic. Oxy-steam reforming, which integrates POX and SMR, has many advantages such as low energy requirements due to the opposite contribution of the exothermic methane oxidation and endothermic steam reforming. With the POX process, the ATR reactor may be maintained under adiabatic conditions, which means that there is no heat transfer to or from the reactor. The adiabatic temperature of reforming may be determined by manipulating input conditions such as oxygen ratio, steam to carbon ratio, preheat temperature, and reactor pressure. The oxygen ratio and steam to carbon ratio significantly affects the conversion and adiabatic temperature. Conversion will rapidly increase when oxygen ratio is increased to a point where the conversion remains at 100%. This is because the excess oxygen is used to oxidize hydrogen (H₂) and carbon monoxide (CO) into water (H₂0) and carbon dioxide (CO₂), as follows:

2H₂+0₂→2H₂0; and

2C0+0₂→2C0₂

As the steam to carbon ratio is increased, theoretically, the hydrogen to carbon monoxide ratio, H₂:CO increases. The steam to carbon ratio is increased by increasing the amount of steam fed to the water shift reactors (i.e., the low-temperature and/or high-temperature water shift reactors). When steam is increased, extra water in the reactor(s) will react with carbon monoxide to produce carbon dioxide. This is referred to as water gas shift reaction, and may additionally occur inside the ATR. For example, steam can be injected into the ATR to balance the kinetics of reaction in the ATR so that both SMR steam methane reforming and autothermal reforming occur, keeping the ATR free of soot formation. The shift reactions will produce more hydrogen, hence increasing the yield of hydrogen and the hydrogen to carbon monoxide ratio. However, this may be true to a certain steam to carbon ratio where the H₂:CO ratio then decreases. This is caused because of the faster rate of oxidation of hydrogen than carbon monoxide. Therefore, the yield of hydrogen will decrease. Reactants to the ATR reactor will be preheated to sustain a certain temperature for the oxidation of methane. If the preheat temperature is increased while other parameters like steam to carbon ratio and oxygen ratio are kept constant, the operating temperature of the ATR reactor will increase. This will result in a higher total conversion of methane. This type of reforming is referred to as auto thermal because by using the right mixture of fuel, oxygen and steam, the POX reaction supplies the heat required to drive the catalytic SMR reaction. Unlike an SMR, an ATR requires no external heat source. This makes an ATR more compact, and it is more likely to have a lower capital cost than SMR. ATR also typically offers high heat transfer efficiency as compared to POX reforming because the excess heat is not easily recovered. Favorable operating conditions of the ATR, the adiabatic reactor temperature, and conversion can be determined by manipulating the steam to carbon ratio and steam ratio.

The syngas generation units may operate at a typical overall steam-to carbon ratio between about 0.2 and 1, or more preferably between about 0.3 and 0.9, or even more preferably between about 0.4 and 0.8, and even more preferably at about 0.60, making the syngas generation units highly competitive from a cost perspective. Additionally, the syngas generation units are particularly suited for producing blue hydrogen because the carbon input into the plant shifts from the fuel to the feed making it easier to capture pre-combustion carbon dioxide.

The reforming of the hydrocarbon feed takes place in two stages—first in an adiabatic pre-reformer and then in a ATR.

Approximately 98% of methane reforming globally is SMR based, utilizing air, the SMRs may require large amounts of air to meet the kinetic oxygen needs of reforming. As such, SMR may rely on greater equipment sizes, plant footprint space, and a diluted syngas with nitrogen. The nitrogen fraction in SMR-produced syngas makes it difficult to capture or separate any carbon dioxide in the syngas, cryogenically. As such, the only option of capturing carbon dioxide from an SMR-produced syngas may include amine or methanol-based solvents.

Cryogenic capture of carbon dioxide with ATR processes is facilitated due to higher concentrations of carbon dioxide in the syngas stream and the greater density and liquefaction temperatures between hydrogen and carbon dioxide.

### Desulfurization—Zinc (Zn)

Natural gas feedstock comprising minor quantities of sulfur compounds (i.e., mercaptan odorants of the natural gas) are required to have the sulfur compounds removed in order to avoid poisoning of the reformer catalyst in the primary reformer and the low temperature shift (LTS) catalyst in the carbon monoxide converter. The LTS conversion catalyst, in particular, used in low temperature converters, is sensitive to deactivation by sulfur and sulfur bearing compounds. Natural gas from the battery limit, after compression, is mixed with recycle gas comprising hydrogen and is heated to between about 200° C. to 600° C., or more particularly between about 300° C. and 500° C., or even more particularly to about 400° C. in the waste heat recovery section of a primary reformer. Hot feed natural gas along with recycle hydrogen enters a hydrogenator filled with hydrogenation catalyst, where organic sulfur compounds are converted to hydrogen sulfide (H₂S). The hydrogen sulfide is absorbed on a specially prepared zinc oxide (ZnO) catalyst in a sulfur absorber. By desulfurization, the sulfur in the natural gas feedstock will be reduced to a low level (i.e., about 0.05 to 0.1 ppm sulfur by weight).

### Adiabatic Pre-Reformer

In the adiabatic pre-reformer, all or most higher hydrocarbons (i.e., gas paraffins such as ethane, propane, butanes, hexanes, other constituents of natural gas) are converted to methane. Further, a minor part of the present methane is steam reformed into hydrogen, carbon monoxide, and carbon dioxide.

### Autothermal Reformer (ATR)

The pre-reformed gas is reacted with oxygen (O₂) in an ATR of the ATR system 200. The chemical reactions taking place in the ATR are a combination of combustion and steam reforming reactions, where the combustion process provides the heat for the endothermic steam reforming reaction.

The ATR may have a compact design, comprising of a refractory-lined pressure vessel with a burner designed for reliability at low steam to carbon ratios, a combustion chamber, and a catalyst bed. The ATR may not use air and may comprise a combination of steam and POX reformers manifesting itself in one compact reactor vessel, compared to a traditional SMR. The ATR reactor vessel comprises a combustion zone and a set catalyst bed among a refractory-lined pressure shell. In the ATR, hydrogen or hydrogen-enriched gas is injected along with steam to produce methane (C-L). The ATR may be operated between temperatures of about 800° C.-1300° C., or more preferably, between about 900° C.-1200° C., or even more preferably between about 950° C.-1050° C. The ATR may be operated at a pressure between about. 10-70 bar, or more preferably between about 20-60 bar, or even more preferably between about 30-50 bar. The ATR may be operated at a steam-to-carbon molar ratio (S/C ratio) between about 0.2-2.0, or more preferably between about 0.3-1.8, or even more preferably between about 0.5-1.5, and may be operated at an oxygen-to-carbon molar ratio (O/C ratio) between about 0.3-1.5, or more preferably between about 0.4-1.3, or even more preferably between about 0.6-1.0. The reformer may operate at temperatures between about 1000° C.-1600° C., or more preferably between about 1100° C.-1500° C., or even more preferably between about 1325° C.-1400° C.

### Heat Recovery

The heat contained in the reformed gas leaving the ATR may be utilized for steam generation as well as to provide the heat required for carbon dioxide removal. A high temperature carbon monoxide shift reactor may be present after the first waste heat boiler and a major part of the carbon monoxide in the process gas may be converted into carbon dioxide. Process condensate (e.g., water condensate) may be separated from the process gas before the process gas enters the carbon dioxide removal step. In embodiments, the temperature of a stream leaving the ATR is decreased so that the stream is within the HTS temperature range so that carbon monoxide can be converted to carbon dioxide by adding steam or basically superheated water (i.e. steam). The temperature can be controlled to further drop to the LTS reactor temperature range, where remaining carbon monoxide is additionally converted to carbon dioxide. The steam or water vapor molecule breaks down from water (H₂0) into hydrogen (H₂) and ½ oxygen (O₂) to aid the conversion from carbon monoxide (CO) to carbon dioxide (CO₂) to pick a ½ oxygen molecule that is ½ O₂ or O.

### Carbon Monoxide Conversion

Carbon monoxide conversion may occur in two adiabatic stages. A high temperature carbon monoxide converter comprises a copper-promoted high temperature shift (HTS) catalyst. High activity, high mechanical strength, and (very) low sulfur are the main characteristics of this variety of catalyst. A low temperature carbon monoxide converter may be loaded with low temperature shift catalyst, which may be characterized by high activity, high strength, and high tolerance towards sulfur poisoning. A top layer of a special catalyst generally termed as a guard catalyst may be installed in a vessel (not depicted) prior to the LTS reactor or on top of the LTS main catalyst as a section protection layer with a liquid dump for moisture. The guard catalyst may absorb any possible chlorine carry over in the gas and also to prevent liquid droplets from reaching the main bed of LTS conversion catalyst.

After reforming, about 13-14% carbon monoxide may be present in the gas (on a dry basis). In the high temperature carbon monoxide converter, the carbon monoxide content may be reduced between about 1.0-6.0 vol %, or more particularly between about 2.0-5.0 vol %, or more particularly between about 3.0-4.0 vol %, and even more particularly to approximately 3.3 vol %. In the process, the temperature of the product gas may be increased from about 300° C.-400° C., or more particularly about 360° C., to about 400° C.-500° C., or more particularly about 435° C. The HTS reactor effluent gas may be cooled in stages to around 150° C.-300° C., or more particularly to around 200° C.-210° C. before entering the low temperature carbon monoxide converter, in which the carbon monoxide content may be reduced to approximately 0.1-0.6 vol %, or more particularly to approximately 0.2-0.5 vol %, or even more particularly to approximately 0.3 vol %, while the temperature of the product gas increases to about 150° C.-300° C., or more particularly to about 200° C.-280° C., or even more particularly to about 220-235° C.

The heat content of the effluent from the high temperature carbon monoxide converter may be recovered in the trim heater, in the high-pressure waste heat boiler, and/or in a high pressure boiler feed water preheater.

### Vapor Pressure Swing Adsorption (VPSA)

VPSA is used to recover and purify hydrogen from a variety of hydrogen-rich streams. A VPSA process may be referred to as a regenerative filter that may filter out “large” molecules such as carbon dioxide and other impurities and may let “small” molecules, such a hydrogen, pass through. The carbon dioxide and other impurities may then be recycled for carbon dioxide liquefaction. The technology relies on differences in the adsorption properties of gases to separate them under pressure and is an effective way of producing (very) pure hydrogen. Using a VPSA process, the hydrogen is recovered and purified at a pressure close to the feed pressure, while adsorbed impurities may be removed by lowering the pressure. The VPSA tail-gas, which comprises carbon dioxide and small quantities of hydrogen, can be separated and captured cryogenically. The entire VPSA process is automatic with the regeneration of the adsorption beds. Some of the most advanced adsorbents on the market have cycles that are optimized for recovery and productivity rates. A (V)PSA system may comprise any number (V)PSA units (i.e., adsorption vessels packed with absorption materials) and may be manufactured for outdoor and unmanned operation and are designed to be both compact and fully skid mounted. Advantages of a VPSA for hydrogen clean-up in the manufacturing of hydrogen are as follows: hydrogen production with up to 99.9999% purity, an on-stream factor typically more than 99.9%, operation can be conducted with a wide variety of feed gases, VPSAs are designed for unmanned, outdoor use, and units are compact and skid-mounted, among other advantages.

Capture of Carbon Dioxide Integrated with VPSA

Cryogenic capture of carbon dioxide (CO₂) may utilize an additional stand-alone cold box from the ASU and/or a number of chiller-based and/or turbo-expander cycles to allow for the cryogenic separation of hydrogen (H₂) gas and carbon dioxide in a dense phase. The present discloser utilizes the adsorbed off gases (i.e., carbon dioxide, trace amounts of oxygen (O₂), and trace amounts of carbon monoxide (CO), and hydrogen species) from the VPSA unit, compresses the off gases, and refrigerates the carbon dioxide into a dense phase for sequestration or petroleum EOR purposes. A molecular sieve dryer and membranes (e.g., polishing membranes) may be used to separate non-condensable impurities (e.g., trace carbon monoxide, trace hydrogen, trace noble gases that do not condense out into liquids), as residue for recycle into the upstream feed of the ATR or to the upstream feed to the VPSA.

Ultra pure hydrogen may be generated, and as per FIG. 1, may be used to generate blue power in a Cogen configuration, or as per FIG. 2 may be used to blend in with the nitrogen generated by the ASU to manufacture blue Ammonia.

### Compression

The synthesis gas may be compressed in a multistage centrifugal gas compressor. Part of the compressor may be used for the recirculation compressor for the synthesis loop.

### Synthesis Loop

The make-up gas from the multistage centrifugal gas compressor after a cooler may be introduced into the synthesis loop between the ammonia chillers. At this point, a considerable part of the ammonia produced in the converter is condensed. The mixture of the synthesis gas and liquid ammonia may pass from the chiller(s) to the ammonia separator, in which the liquid ammonia is separated. At the outlet, the gas comprises between about 1.0-7.0 vol %, or more particularly between about 2.0-6.0 vol %, or more particularly between about 3.0-5.0 vol %, or even more particularly about 4.0 vol % ammonia (NH₃) and the temperature may be approximately 0° C.

In embodiments, condensation of ammonia traces and impurities in the make-up gas (e.g., water, carbon dioxide, non-ammonia gases such as oxygen, argon, or other materials that slip through the nitrogen wash), may allow for the traces and impurities to be absorbed in the liquid ammonia phase and removed with the liquid ammonia in the separator. In the hot heat exchanger, the gas may be heated to the converter inlet temperature by heat exchange with gas coming from the boiler feed water (BFW) preheater.

A considerable part of the heat content of the impurity gases (i.e., impurity gases that have BTU content) leaving the converter may be recovered in the waste heat boiler and in the BFW preheater. After the BFW preheater, the gas is cooled in the hot heat exchanger. Make-up synthesis gas from compressor discharge is added in the pipe length between the ammonia chillers. The make-up gas comprises a small quantity of inert gases such as methane (CH₄) and argon (Ar). In order to prevent these gases from accumulating in the loop, a certain quantity of gas circulating in the ammonia synthesis loop is purged and circulated back into the ATR.

The purge gas may be vented from the ammonia synthesis loop after a first ammonia chiller (i.e. prior to the make-up gas addition), where the concentration of inert gases in the loop is at a maximum. The purge gas is sent to purge gas chiller, where ammonia vapor in the purge gas is condensed and separated in the purge gas separator and returned to the bottom of the ammonia separator. The aqueous ammonia is distilled in the distillation column together with aqueous ammonia from the off-gas absorber, and the recovered ammonia is added to the ammonia product in the let-down vessel.

The liquid ammonia may be depressurized and taken to the letdown vessel, in which the gases dissolved in the liquid ammonia may be liberated. The letdown gas may comprise a considerable amount of ammonia, which may be recovered by a water wash in the off-gas absorber. The off-gases may be mixed and sent to the fuel header. In the event product ammonia is sent to storage, the product ammonia may be flashed cooled to temperature between about −50 and −20° C., or more particularly to a temperature between about −30° C. and −40° C. in the flash vessel.

The ammonia synthesis converter comprises a pressure shell and a basket. The basket comprises at least two catalyst bed heat exchangers and at least one interbed heat exchanger placed in the center of the first and second catalyst bed, respectively. The main part of the synthesis gas (i.e., the majority of the mass rate of the synthesis gas) is introduced into the converter through the inlet at the bottom of the converter and passes upwards through the outer annulus between the basket and the pressure shell, keeping the latter cooled. The synthesis gas then passes to the bottom tube sheet of the first interbed heat exchanger through transfer pipes in the heat exchanger and passes the tubes in upward direction thereby cooling the exit gas from the first bed to the inlet temperature of the second bed. The remaining gas, that is the cold by-pass gas, may be introduced at the bottom of the converter. In the top of the converter pipe, cold by-pass gas may mix with the gas leaving the tube side of the two interbed heat exchangers. The amount of cold by-pass gas controls the inlet temperature to the first bed. After mixing, the gas flows through the space below the basket cover to the annulus of the panels around the first catalyst bed. From the panels, the gas passes the first catalyst bed in an inward direction and then flows to the annulus between the first catalyst bed and the first interbed heat exchanger. Even gas distribution in the catalyst bed is ensured by means of appropriate perforation in the panels. The effluent from the first catalyst bed passes the shell side of the first interbed heat exchanger for cooling to the proper inlet temperature to the second catalyst bed by heat exchange with gas introduced through the tube side of the first interbed heat exchanger, as described above. From the shell side of the first interbed heat exchanger, the gas is transferred to the second catalyst bed through the panels around the bed. The temperature inlet of the second catalyst bed is controlled by means of the by-pass around the BFW preheater, adjusting the gas temperature to the converter inlet. The gas leaving the second catalyst bed passes the perforated center tube and flows to the converter outlet. During start-up, hot gas from the start-up heater, is introduced through the cold by-pass pipe at the top of the converter.

### Refrigeration Circuit

The refrigeration circuit may comprise a compressor unit, a condenser, an accumulator, and a number of chillers. The refrigeration circuit may be designed to operate in two modes depending on whether the ammonia is sent to storage as a cold product or, to a future downstream process as a hot product. Liquid ammonia flows from the accumulator, through the product heater, to the first synthesis loop chiller, where the ammonia is expanded. The liquid ammonia is transferred to the second synthesis loop chiller, and the purge gas chiller, where the ammonia is further expanded. Evaporated ammonia from the chillers and the flash vessel may be compressed by the ammonia compressor. Suction pressures correspond to the pressures in the flash vessel and the chillers and allow for the flow from one chiller to another. After compression, the ammonia is condensed in the ammonia condenser, and collected in the accumulator. Inert gases accumulating in the refrigeration system are vented from the ammonia accumulator. Ammonia is condensed in the inert vent gas chiller and separated in the inert vent gas separator. The gas, which still contains some ammonia, is sent to the ammonia recovery unit. Evaporated ammonia is sent to the ammonia compressor.

The present disclosure utilizes the regenerant liquid air streams from the ASU to chill, refrigerate, and liquefy the ammonia product. Liquid nitrogen at the ASU operates at about −77K or about −350° C. and may need to be processed for ammonia synthesis while balancing being reprocessed in the ASU. This will save significant costs associated with refrigeration cycle compression. A nitrogen wash cold box can be installed to cleanup any contaminant traces (i.e., Nobel gases such as oxygen from the ASU distillation of nitrogen and oxygen, argon, and other Nobel gases that make it through the nitrogen wash) within the nitrogen and hydrogen.

### Ammonia Recovery

Inert gas and let down gas from the letdown vessel (i.e., a vessel where pressure is reduced and any ammonia products get reabsorbed into aqueous ammonia and are regenerated) are introduced to the off-gas absorber and ammonia is washed out with water. The aqueous ammonia from purge gas absorber and off-gas absorber may be sent to the distillation column, where ammonia is distilled off and returned to the letdown vessel.

### Liquid Nitrogen Wash

Traces of carbon oxides (i.e., carbon monoxide, carbon dioxide, or a combination thereof), argon, methane, and other compounds may be removed through process equipment of the cryogenic separation installed in the cold box, which may be covered with a metal shell. The cold box void is filled with insulation material (e.g., perlite) to prevent heat input.

The liquid nitrogen wash is mainly used to purify and prepare ammonia synthesis gas for the process. The wash is usually the last purification step upstream of ammonia synthesis. The liquid nitrogen wash has the function to remove residual impurities from a crude hydrogen stream and to establish a stoichiometric H₂/N₂ ratio of 3:1. In some embodiments, carbon monoxide must be completely removed since it is poisonous for the ammonia synthesis catalyst. Argon and methane are inert components enriching in the ammonia synthesis loop, and if not removed, a syngas purge or expenditures for purge gas separation may be required.

Raw hydrogen and high pressure nitrogen may be fed to the liquid nitrogen wash unit. Both streams may be cooled down against product gas. Raw hydrogen may be fed to the bottom of the nitrogen wash column and some condensed nitrogen liquid may be fed to the top. Trace components may be removed and separated as fuel gas and circulated to the syngas process. To establish the desired H₂/N₂ ratio, high pressure nitrogen may be added to the process stream.

### Process Condensate Recovery

The condensate stripping section may treat process condensate from the separator and excess condensate, if any, may be carried by regenerated carbon dioxide from the carbon dioxide removal section. The condensate stripping may remove a substantial part of ammonia, and carbon dioxide from the condensate before the treated condensate is passed to the demineralized water unit outside main ammonia plant battery limit.

The impurity level of the process condensate depends on various factors such as front-end operating conditions, catalyst types, catalyst age, etc. In some embodiments, the condensate is heated up from around 40° C.-90° C., or more particularly from about 70° C., to about 200° C.-250° C., or more particularly to about 220° C.-230° C. in the condensate feed and/or effluent exchanger. The hot condensate enters the top tray of a condensate recovery stripper, and during its passage down the tower, ammonia and carbon dioxide are stripped off by means of medium pressure (MP)-steam fed at tower bottom. The stripped gases leave together with MP-steam and enter a knockout (KO) drum, before going to reforming section. The pressure maintained in the condensate stripping section is controlled by pressure control operating in split range. In embodiments, the differential pressure may be measured and is expected to be in the operating range. Differential pressure above the set pressure may not be preferred as it indicates foaming or overloading with steam. The pressure level in the KO drum is measured carefully and is provided with a high alarm. In embodiments, there may not be any liquid in the KO drum. Stripped process condensate is removed from the bottom of the KO drum. It is cooled up to battery limit delivery temperature of around 40° C.-50° C., and more particularly of about 46° C. The process condensate is cooled from around 230° C.-270° C., and more particularly from around 245° C.-255° C. to about 80° C.-100° C., or more particularly to about 90-95° C. Further, the process condensate is cooled by cooling water to around 30° C.-60° C., or more particularly to around 40° C.-50° C., or even more particularly to around 45° C. The condensate level is controlled by a level indicator controller. The flow of stripped process condensate as well its quality may be monitored on-line. Depending on the quality, stripped process condensate may be sent to a polishing demineralization unit, or to cooling tower basin and/or effluent treatment plant. If the conductivity of the stripped process condensate is below about 100 μs/cm, the water may be used as make-up water for the demineralized water production. If the conductivity is between about 100 μs/cm and 300 μs/cm, the water may be used as make up water for the cooling water. If the conductivity is above about 300 μs/cm, the water may be sent to effluent treatment plant.

### Steam System

All or a portion of the waste heat available in the system 101 and/or 201 (i.e., a cumulation of some or all waste heat sources from the exothermic processes such as the ATR, HTS, LTS, and ammonia synthesis and/or waste heat from cogeneration from the exhaust such as hydrogen combustion) may be utilized to produce high-pressure steam. For example, utilizing high-temperature and low-temperature shift gas in the water shift reaction of carbon monoxide into carbon dioxide is exothermic reaction that gives off heat. Additionally, ammonia synthesis gas (i.e., hydrogen and nitrogen) synthesized into ammonia is an exothermic reaction. The high-temperature, low-temperature, and ammonia synthesis reactions may be controlled with water cooling that goes into HP steam. As such, high pressure (HP) steam may be produced in the reformed gas ATR process, by shift converted gas waste heat, and/or in the synthesis loop waste heat. The HP steam generated in the ammonia plant covers the demands of the ammonia plant at normal operating conditions (i.e., conditions that balance the steam and energy process needs of the plant by steam for power and/or heat) and any remaining steam may be exported to a power plant. A majority of the steam produced in the ammonia plant may be expanded to medium pressure (MP) steam in the back pressure part of an HP steam turbine, driving the synthesis gas/recirculation compressor. The power demand of synthesis gas/recirculation compressor is balanced by means of the condensation part of synthesis gas steam turbine. The MP steam extracted from synthesis gas steam turbine may be used partly as process steam and partly as motive force for condensing turbines driving the process air compressor and refrigeration compressor steam turbine and HP boiler feed pumps in the power plant. MP steam may be used in the ammonia recovery section. Low pressure (LP) steam may be extracted and used for deaeration of HP boiler feed water. An expected ammonia product comprises greater than about 98 wt. % ammonia, and more particularly greater than about 99 wt. %, and more particularly greater than about 99.5 wt. %, and even more particularly between about 99.5 and 99.9 wt. %. The expected ammonia product comprises less than 0.5 wt. % water, and more particularly less than about 0.2 wt. % water, less than or about 5 ppm of oil, and carbon dioxide slip from the absorber in amounts less than about 500 ppm.

### CoGen Power Plant

A combined cycle power plant may be installed in some systems to offset the high demand cost associated with black start and to facilitate long lead times associated with grid connection. Additionally, power demands associated with the facility, as well as exothermic heat released from reaction synthesis, makes financial and operational sense to integrate power generation.

A hydrogen fired gas turbine with a heat recovery steam generator (HRSG) integrate HP, MP, and LP steam produced for the facility. For example, the HRSG may integrate the HP, MP, and LP in one continuous system in which LP steam is heated into MP, and MP is heated into HP in the boiler, maximizing HP steam for steam turbine power generation. The HRSG can be supplementary fired with hydrogen when necessary to generate additional power. Supplemental low-grade steam not used for power may be quenched into condensate as part of the boiler feed system. All major equipment drivers may be steam driven, utilizing reheated MP steam with LP steam outlets as LP process steam for heating.

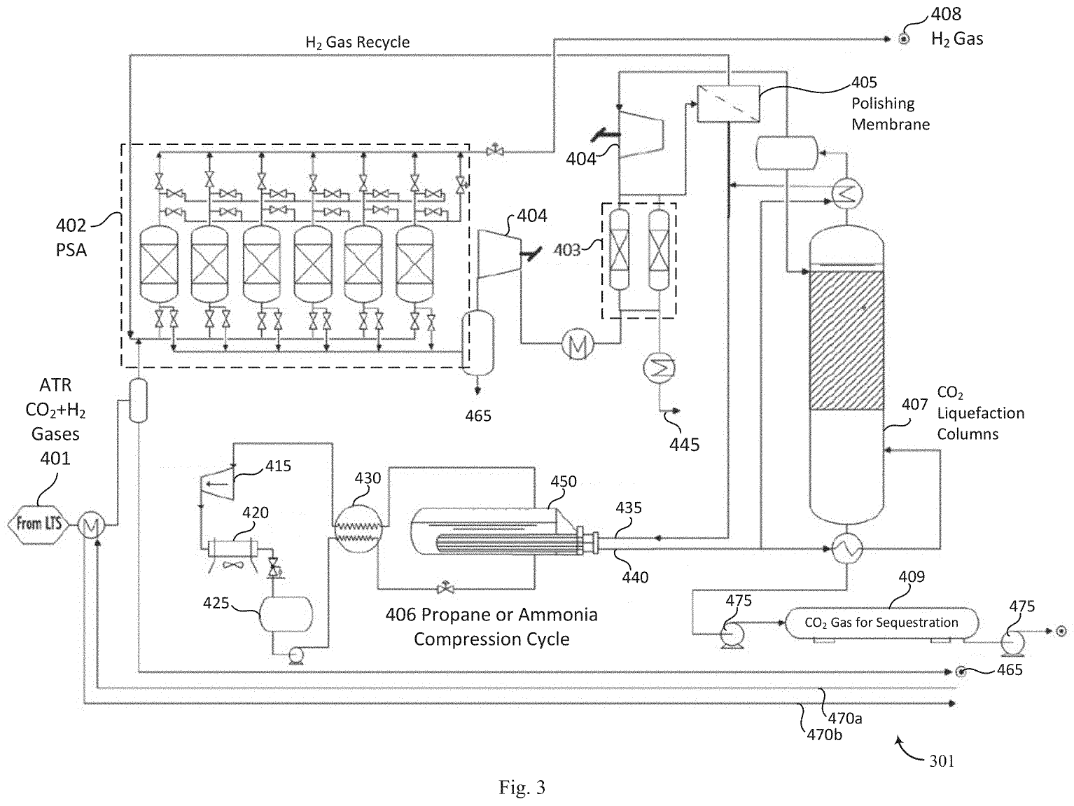

FIG. 3 depicts an example process 301 using pressure swing adsorption (PSA) and a liquefaction chiller that supports methods and systems for cryogenically separating carbon dioxide and hydrogen from a syngas stream according to the present disclosure is depicted. The process 301 may be an example cryogenic carbon dioxide capture process for hydrogen manufacturing, or another manufacturing processes. The process 301 may utilize PSA system 402 and chiller liquefaction. The process 301 may further include a syngas stream 401, a molecular sieve dryer 403, one or more multi-stage compressors 404, a polishing membrane 405, a compression cycle 406, a liquefaction column 407, and may result in a hydrogen stream 408, and captured carbon dioxide 409, as described below.

With reference to syngas stream 401, hot gases from the low temperature water shift reactor (as described herein with reference to FIGS. 1 and 2) may enter a heat exchanger, or some other cooling element, of the carbon dioxide capture process 301 to cool the syngas stream 401 to the appropriate adsorption temperature for the PSA system 402. The heat exchanger may utilize input deaerator water 470a and may output deaerator water 470b.

The PSA system 402 may comprise a multibed regenerative process that adsorbs impurities and primarily carbon dioxide at pressure. The adsorbed carbon dioxide is captured or retained in the adsorbent media letting the hydrogen pass though at pressure. The PSA system 402 is a high efficiency separation and regenerative process where the beds release the carbon dioxide and impurities once the bed pressure is decreased, resulting in a carbon-dioxide rich stream being output from the bottom of the PSA 402 Prior to the PSA 402, water condensate 465 may be separated from the syngas output. Additionally, the carbon-rich stream output from the bottom of the PSA 402 may comprise water, and may be passed through another separator to further remove water condensate 465.

The carbon-dioxide rich stream existing the bottom of the PSA 402 is water saturated and the water should be removed prior to cryogenic separation, as water freezes. As such, a molecular sieve dryer 403 may remove all or a majority of the water moisture from the carbon-dioxide rich stream existing the bottom of the PSA 402 to a (very) low water dewpoint so to prevent any moisture from freezing in the cryogenic liquefaction column 407. Recycle mole sieve regeneration gas 445 is output from the molecular sieve dryer 403.

The one or more multi-stage compressors 404 may be centrifugal multistage compressors, where the pressure may be near or within vacuum range. The stages of the compressors 404 are selected to provide a (very) low pressure during PSA regeneration and a sufficient pressure to meet the downstream process requirements.

The polishing membrane 405 may further separate remaining light gases (e.g., hydrogen) from heavy gases (e.g., carbon dioxide). In some embodiments, hydrogen passes through the membrane 405 while carbon dioxide and other minor impurities do not pass through. The carbon dioxide and other impurities may be sent from the polishing membrane 405 to the cryogenic chiller where the temperature of the outlet stream 440 becomes that equal to near equal to liquefaction temperatures. For example, a carbon dioxide inlet stream 435 may be fed to a flooded tube chiller 450.

The compression cycle 406 may be propane or ammonia compression cycle using the flooded tube chiller 450, where the tubes of the chiller may be under propane or ammonia liquid level with the boil-off of the refrigerant in a cycle configuration. The compression cycle may further utilize a cross exchanger 430, a screw compressor 415, a condenser 420, and an accumulator 425. The outlet stream 450 may be fed to the liquefaction column 407. A flooded tube chiller 450 is filled with either ammonia liquid or propane liquid at about −30 to −40° C., or more particularly at about −35° C., or even more particularly at about −37° C., depending on which process is used. The refrigerant floods the shell to keep tubes under level. The carbon dioxide is in the tube side of the chiller 450 and as the carbon dioxide is cooled, it evaporates the ammonia or propane on the shell chilling the carbon dioxide into near liquid phase (i.e., dense phase). The chilled carbon dioxide returns to the carbon dioxide liquefaction column 407 where the carbon dioxide is fully liquified.

The liquefaction column 407 provides retention (i.e. storage) of the liquified carbon dioxide and allows for any light gas, such as hydrogen, that is still remaining to slip through and get redirected to the PSA inlet or to the ATR feed.

A resulting hydrogen stream 408 from the top of the PSA 402 may be output from system 300. The stream 408 may comprise high purity and high quality hydrogen that may be used as blue hydrogen for fuel and/or for the manufacturing of blue ammonia, among other uses. The hydrogen stream 408 manufactured in the integrated process disclosed herein may be liquified through an alternative cryogenic cycle by further integrating the ASU liquid nitrogen gases in a turboexpander liquefaction process to manufacture and store liquid hydrogen for transportation utilization.

Captured carbon dioxide 409 may be output from the liquefaction column 407 and in some embodiments, may be pumped (via a pump 475) and stored in dense phase in a low pressure storage vessel (e.g., at about 300 psig). In some embodiments, the captured carbon dioxide 409 is pumped and disposed into a saline aquifer reservoir deep in the ground or used as a miscible fluid in a depleted oil reservoir for sequestration or utilized as a solvent with other solvents such as propane, butane, hexanes for enhanced heavy oil or bitumen recovery such as steam-assisted gravity drainage (SAGD).

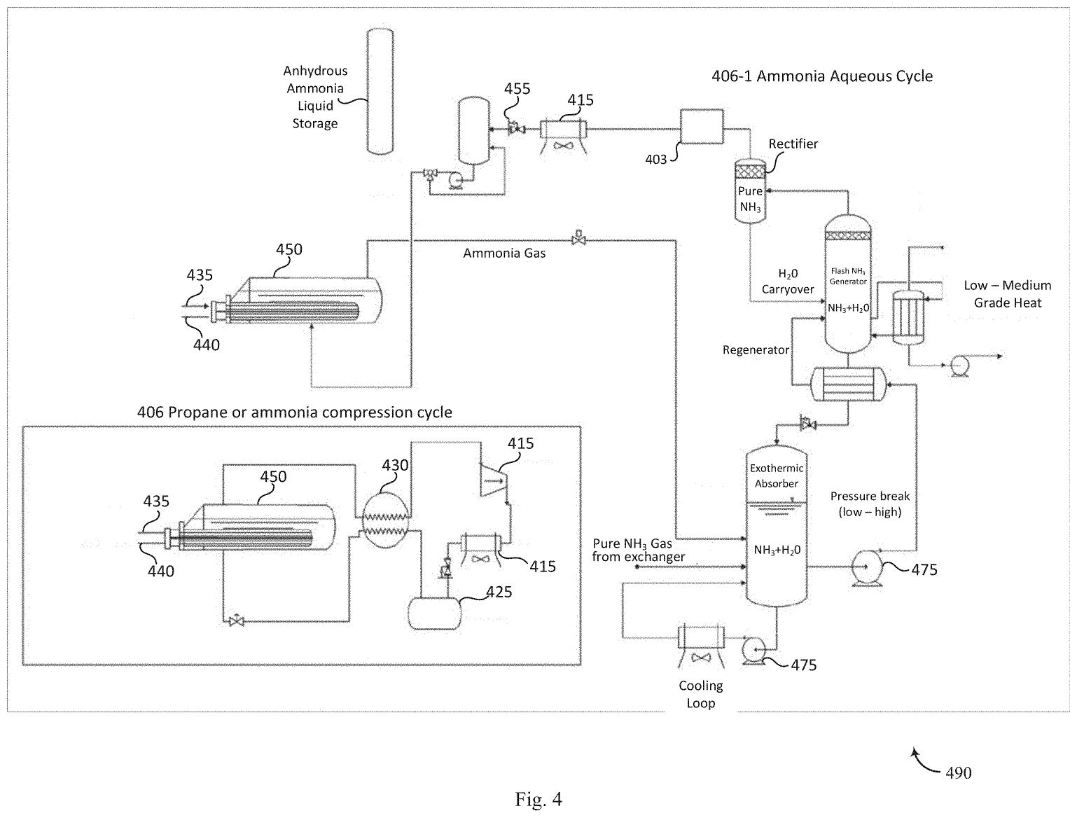

FIG. 4 depicts an example process 490 using liquefaction cycles that support methods and systems for cryogenically separating carbon dioxide and hydrogen from a syngas stream according to the present disclosure is depicted. The process 490 depicts multiple liquefaction cycles (i.e., cycles 406 and 406-1) that may be used interchangeably or in combination. The liquefaction cycles 406 and/or 406-1 may be used for the cryogenic capture of carbon dioxide in the manufacturing of hydrogen, among other manufacturing processes. The liquefaction cycles 406 and/or 406-1 may be applied to the process 301 with reference to FIG. 3, or to any other process described with reference to FIGS. 1, 2, and 5 through 7.

Liquefaction cycle 406 may comprise a propane or ammonia refrigeration compression cycle using propane or ammonia as the refrigerant, as described with reference to FIG. 3. Another refrigerant may be used in lieu.

Liquefaction cycle 406-1 may comprise an ammonia-water cycle where aqueous ammonia is heated in a regenerator vessel at temperatures below the evaporation temperature of water at a respective high pressure allowing (only) the ammonia to boil off to vapor from the aqueous ammonia solution. In embodiments, the aqueous ammonia is heated to a temperature less than 100° C., or more particularly to a temperature between about 80° C. and 90° C., or even more particularly to a temperature ranging between about 85° C. and 90° C. In embodiments, the aqueous ammonia is heated at a pressure ranging between about 200 psi and 600 psi, or more particularly between about 300 psi and 500 psi. The ammonia gases are dried then cooled and expanded through a Joule Thomson (JT) valve 455 and/or a turboexpander 415. In embodiments, there may be sufficient flow through a turbo expander 415 to liquefy the ammonia to about −33° C. for carbon dioxide liquefaction in a flooded tube Chiller 450. If the flow is small, the JT valve 455 may drop the ammonia temperature and not extract energy, but if the flow is large, the turboexpander 415 may also drop the temperature ad at the same time recover energy from the expansion. In embodiments, prior to the JT valve 455 and/or turboexpander 415, the ammonia stream may pass through a molecular sieve dryer 403 for removal of water condensable.

The liquid ammonia boils-off and is reabsorbed with water into aqueous ammonia. By reintroducing the ammonia gas with the water in the absorber, the process is exothermic and gives off heat that must be cooled. The aqueous ammonia is then pumped into a higher-pressure regenerative process. With reference to the exothermic absorber, as mixing pure ammonia with water to remake aqueous ammonia is an exothermic reaction, the pumping from low pressure to a higher pressure of the cycle sets conditions for the cycle without compression, which is costly. The exothermic absorber may include or may otherwise be integrated with a cooling loop to achieve the cooling requirements needed to meet the temperature of the exothermic absorber. The ammonia water cycle is a process that relies on the thermodynamic properties of the ammonia and on the deferential pressure of the low and high pressures to drive the regeneration cycle. The benefit of this cycle is that expensive compression is not necessary, it is extremely reliable, and takes very little energy to boil-off the ammonia from the ammonia water solution. This cycle 406-1 is ideal for low grade heat recovery systems below the water boil temperatures and utilizing the low-grade heat recovery for the liquefaction of carbon dioxide. The horsepower pump 475 capacities are a fraction of the horsepower requirements of the compression refrigeration cycle, make it ideal from a reliability, safety, and costs perspective.

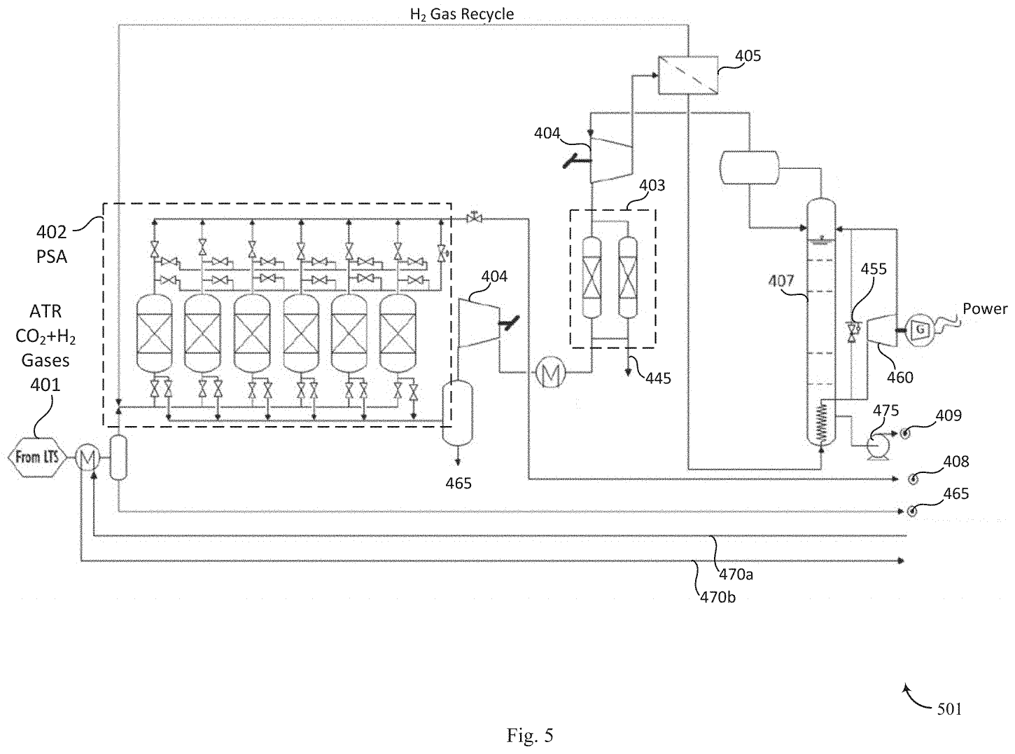

FIG. 5 depicts an example process 501 using a PSA and expander liquefaction that supports methods and systems for cryogenically separating carbon dioxide and hydrogen from a syngas stream according to the present disclosure is depicted. The process 501 may be an example cryogenic carbon dioxide capture process for hydrogen manufacturing, or another manufacturing process. The process 501 may utilize PSA system 402 and expander liquefaction.

The syngas stream 401, the PSA system 402, the molecular sieve dryer 403, the multi-stage compressors 404, and the polishing membrane 405, as described with reference to FIG. 3 also apply with reference to FIG. 5. However, the propane or ammonia compression cycles 406 and the aqueous ammonia cycle 406-1, as described with reference to FIGS. 3 and 4, are not utilized. Instead, the syngas is compressed further to higher pressures for expansion through a JT valve 455 or turboexpander 460. This compression may also include a higher-pressure membrane.

The JT valve 455 and/or the turboexpander 460 may expand the pressure of the syngas stream to a cryogenic temperature where the carbon dioxide liquefies and stabilizes in the liquefaction column 407.

Similarly or the same as with reference to FIG. 3, the carbon dioxide liquefaction column 407 may intake the carbon dioxide syngas stream, where the carbon dioxide undergoes retention time and is stabilized with any remaining light gases being separated and cycled back into the process 501.

Similarly or the same as with reference to FIG. 3, a hydrogen stream 408 (i.e., high purity hydrogen) may be used as blue hydrogen for fuel and/or for the manufacturing of blue Ammonia, among other uses.

Similarly or the same as with reference to FIG. 3, captured carbon dioxide 409 may be pumped and stored in dense phase in a low pressure storage vessel (at about 300 psig) from where it may further be pumped and disposed into a saline aquifer reservoir deep in the ground or used as a miscible fluid in a depleted oil reservoir for sequestration, or may be utilized as a solvent with other solvents such as propane, butane, hexanes for enhanced heavy oil or bitumen recovery such as SAGD.

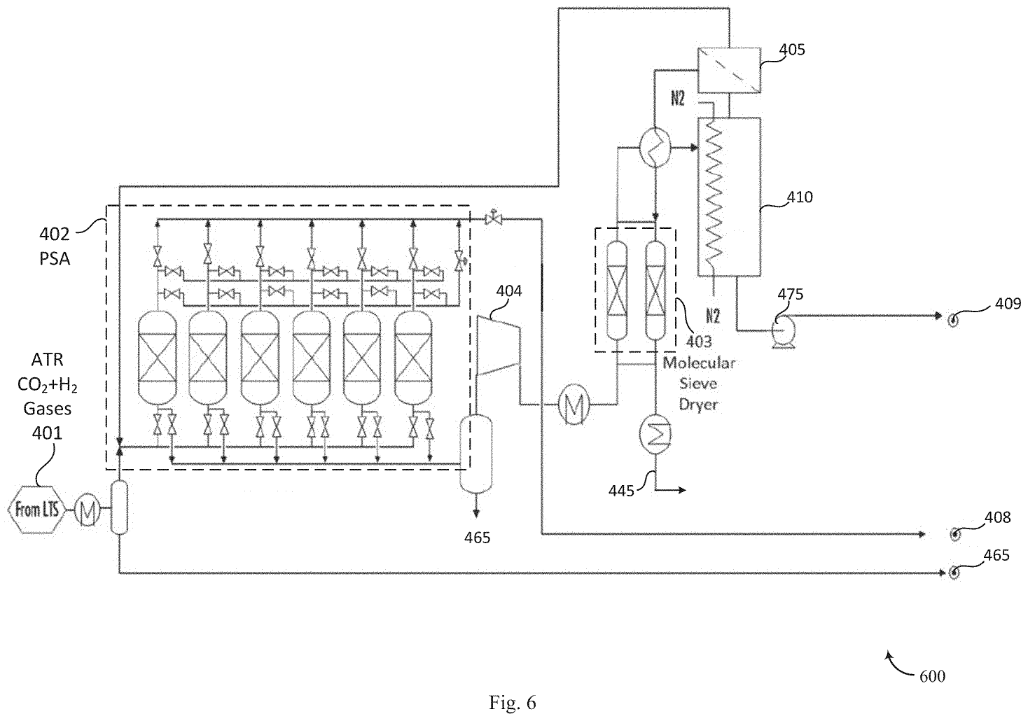

FIG. 6 depicts an example process 600 using a PSA and an air separation unit that supports methods and systems for cryogenically separating carbon dioxide and hydrogen from a syngas stream according to the present disclosure is depicted. The process 600 may be an example cryogenic carbon dioxide capture process for hydrogen manufacturing, or another manufacturing process. The process 600 may utilize PSA 402 and cryogenic nitrogen from the ASU.

The syngas stream 401, the PSA system 402, the molecular sieve dryer 403, the multi-stage compressors 404, and the polishing membrane 405, as described with reference to FIGS. 3 and 5 also apply with reference to FIG. 6. However, the propane or ammonia compression cycles 406 and the aqueous ammonia cycle 406-1 are not utilized.

Rather, the syngas is compressed, dried, and separated through a membrane and is integrated into a supplemented cold box in the ASU, where the carbon dioxide is cryogenically condensed into liquid-dense phase by cross exchanging the carbon dioxide with cold nitrogen liquids from the ASU. The nitrogen boil-off from the cross exchanger is reabsorbed into the ASU process in a cyclic manner with the ASU. This may result in a higher compression load for the BAC and MAC ASU compressors, however, should there not be a requirement for liquid nitrogen, the nitrogen will be vented to the atmosphere and any load impacts to the BAC and MAC air compressors will be minimal or none.

For example, a cold box exchanger 410 (i.e. a supplemental ASU cold box exchanger) may be implemented in FIG. 6 for carbon dioxide liquefaction. A small stabilizer vessel may be installed in a similar fashion as column 407 with reference to FIG. 5, where the carbon dioxide liquefaction column 407 undergoes retention time and stabilizes any remaining light gases being separated and cycles them back into the system 600.

Similarly or the same as with reference to FIGS. 3 and 5, a hydrogen stream 408 (i.e., high purity hydrogen) may be used as blue hydrogen for fuel and/or for the manufacturing of blue Ammonia, among other uses.

Similarly or the same as with reference to FIGS. 3 and 5, captured carbon dioxide 409 may be pumped and stored in dense phase in a low pressure storage vessel (at about 300 psig) from where it may further be pumped and disposed into a saline aquifer reservoir deep in the ground or used as a miscible fluid in a depleted oil reservoir for sequestration, or may be utilized as a solvent with other solvents such as propane, butane, hexanes for enhanced heavy oil or bitumen recovery such as SAGD.

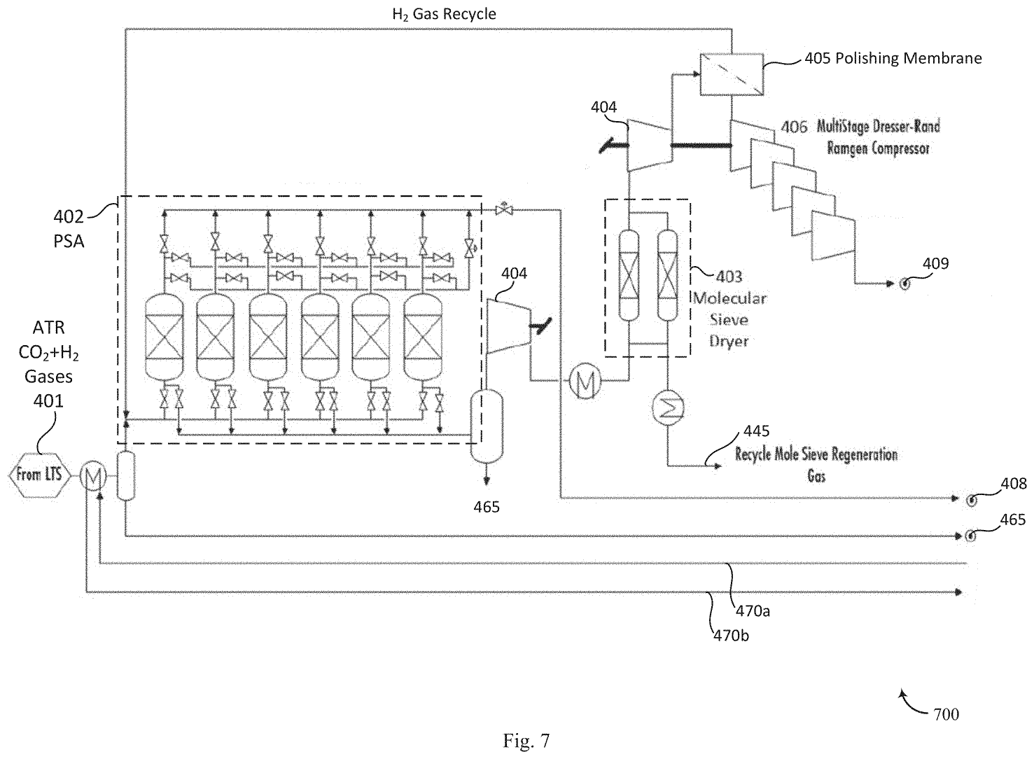

FIG. 7 depicts an example process 700 using a PSA and carbon dioxide compression that supports methods and systems for cryogenically separating carbon dioxide and hydrogen from a syngas stream according to the present disclosure is depicted. The process 700 may be an example cryogenic carbon dioxide capture process for hydrogen manufacturing, or another manufacturing process. The process 700 may utilize PSA 402 and carbon dioxide compression.

The syngas stream 401, the PSA system 402, the molecular sieve dryer 403, the multi-stage compressors 404, and the polishing membrane 405, as described with reference to FIGS. 3, 5, and 6 also apply with reference to FIG. 7. The propane or ammonia compression cycles 406 and the aqueous ammonia cycle 406-1 as described with reference to FIGS. 3 and 4, however, are not utilized in FIG. 7. Additionally, the multistage compressor 404 is utilized to compress the sequestered carbon dioxide and any trace impurities for disposal into deep saline aquifers or for EOR purposes.

In some embodiments, a de-oxy system (not depicted) may be used with the multi-stage compressor 404 to meet a particular specification of oxygen content in the carbon dioxide.

Similarly or the same as with reference to FIGS. 3, 5, and 6, a hydrogen stream 408 (i.e., high purity hydrogen) may be used as blue hydrogen for fuel and/or for the manufacturing of blue Ammonia, among other uses.

Similarly or the same as with reference to FIGS. 3, 5, and 6, captured carbon dioxide 409 may be pumped and stored in dense phase in a low pressure storage vessel (at about 300 psig) from where it may further be pumped and disposed into a saline aquifer reservoir deep in the ground or used as a miscible fluid in a depleted oil reservoir for sequestration, or may be utilized as a solvent with other solvents such as propane, butane, hexanes for enhanced heavy oil or bitumen recovery such as SAGD.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

1. A system, comprising:
an auto-thermal reformer, wherein the auto-thermal reformer comprises a natural gas inlet stream and outputs a syngas stream comprising at least carbon dioxide and hydrogen;
a pressure swing adsorption system that receives the syngas stream as an input, wherein the pressure swing adsorption system separates the syngas stream into a hydrogen-rich stream and a carbon dioxide-rich stream, and wherein the pressure swing adsorption system outputs the hydrogen-rich stream and the carbon dioxide-rich stream; and
an air separation unit comprising a gas having a cryogenic temperature, wherein the gas is thermally contacted with the carbon-dioxide rich stream to cool the carbon dioxide-rich stream to the cryogenic temperature and form a dense phase.

2. The system of claim 1, further comprising:
a molecular sieve dryer following the pressure swing adsorption system, wherein the molecular sieve dryer removes water from the carbon dioxide-rich stream.

3. The system of claim 2, further comprising:
one or more multi-stage compressors, wherein the one or more multi-stage compressors are located subsequent to the pressure swing adsorption system, and wherein the one or more multi-stage compressors are located prior to the molecular sieve dryer, or subsequent to the molecular sieve dryer, or a combination thereof.

4. The system of claim 1, further comprising:
one or more membranes following the pressure swing adsorption system that separate remaining hydrogen from the carbon dioxide-rich stream, wherein the one or more membranes output a second hydrogen rich-stream that is recycled to the pressure swing adsorption system and output a second carbon dioxide-rich stream.

5. The system of claim 1, wherein the gas having the cryogenic temperature comprises nitrogen, carbon dioxide, or both.

6. The system of claim 1, wherein the auto-thermal reformer is integrated with a high-temperature shift reactor and a low-temperature shift reactor, and wherein an output of the auto-thermal reformer is an input to the high-temperature shift reactor, and an output of the high-temperature shift reactor is an input to the low-temperature shift reactor.

7. The system of claim 1, further comprising:
a flooded tube chiller integrated with a propane or ammonia compression refrigeration cycle that aids in the cryogenic conversion of the carbon dioxide-rich stream to the dense phase.

8. The system of claim 1, further comprising:
a cogeneration power plant, wherein the hydrogen-rich stream is input to the cogeneration plant as a fuel source.

9. The system of claim 1, further comprising:
an ammonia synthesis system, wherein the hydrogen-rich stream and nitrogen are input to the ammonia synthesis system to synthesize ammonia.

10. A system, comprising:
a pressure swing adsorption system comprising a syngas stream as an input, wherein the pressure swing adsorption system separates the syngas stream into a hydrogen-rich stream and a carbon dioxide-rich stream, and wherein the pressure swing adsorption system outputs the hydrogen-rich stream and the carbon dioxide-rich stream; and
a carbon dioxide capturing unit that receives the carbon-dioxide rich stream and cryogenically converts the carbon dioxide-rich stream to a dense phase.

11. The system of claim 10, wherein the carbon dioxide capturing unit comprises:
a compression cycle comprising one or more of a flooded tube chiller, a cross exchanger, a screw compressor, a condenser, and an accumulator, wherein the compression cycle is an ammonia or propane compression cycle.

12. The system of claim 10, wherein the carbon dioxide capturing unit comprises:
an ammonia aqueous cycle comprising one or more of an aqueous ammonia generator, an exothermic absorber, a rectifier, a Joule Thomson valve, and a flooded tube chiller.

13. The system of claim 10, wherein the carbon dioxide capturing unit comprises:
one or more multi-stage compressors, polishing membranes, and molecular sieve dryers.

14. The system of claim 10, wherein the carbon dioxide capturing unit comprises:
a liquefaction column, a Joule Thomas valve, a turboexpander, or a combination thereof.

15. The system of claim 10, wherein the carbon dioxide capturing unit comprises:
a cold box associated with an air separation unit, wherein the carbon-dioxide rich stream is thermally contacted with cryogenic nitrogen liquids from the air separation unit.

16. The system of claim 10, wherein the carbon dioxide capturing unit comprises:
a de-oxy system to achieve a particular oxygen content in the carbon-dioxide rich stream.

17. The system of claim 10, further comprising:
one or more of a cogeneration power plant and an ammonia synthesis unit, wherein the hydrogen-rich stream is input to the cogeneration plant as a fuel source, and wherein the hydrogen-rich stream is input to the ammonia synthesis unit with nitrogen to synthesize ammonia.

18. A method, comprising:
producing, from a natural gas stream, a syngas comprising at least hydrogen and carbon dioxide;
separating at least a portion of the hydrogen from the syngas using pressure swing adsorption to form a hydrogen-rich stream and a carbon dioxide rich stream; and
passing the carbon dioxide-rich stream through a carbon dioxide capture unit to cryogenically convert the carbon dioxide-rich stream to a dense phase to form dense phase carbon dioxide.

19. The method of claim 18, wherein passing the carbon dioxide-rich stream comprises:
thermally contacting a gas having a cryogenic temperature from an air separation unit to cryogenically convert the carbon dioxide-rich stream to the dense phase carbon dioxide.

20. The method of claim 19, further comprising:
using the gas having the cryogenic temperature from the air separation unit as a refrigerant for ammonia liquefaction in an ammonia synthesis process, for hydrogen liquefaction in a hydrogen synthesis process, or a combination thereof.
